(19) United States
(12) Patent Application Publication
(10) Pub. No.: US 2010/0301186 A1
(43) Pub. Date: Dec. 2, 2010

(54) ADJUSTABLE SUPPORT DEVICE

(76) Inventor: Min-Lon Chuang, Taipei County (TW)

Correspondence Address: Min-Lon Chuang, 235 Chung - Ho Box 8-24, Taipei, 235, TW

(21) Appl. No.: 12/471,475

(22) Filed: May 26, 2009

(51) Int. Cl. F16M 11/26

(52) U.S. Cl. 248/422; 248/157

(57) ABSTRACT

An adjustable support device includes a support, a lift mechanism, and a pulley unit. The support includes at least two casings which are slidably connected with each other so as to adjust the length of the support. The lift mechanism includes a threaded rod screwed into a nut for changing the distance between the casings. The pulley unit is adapted for driving the casings. The present invention provides a labor-saving effect for operation.

### BACKGROUND OF THE INVENTION

1. Field of the Invention

The present invention relates to an adjustable support device, and more particularly to a support in conjunction with a lift mechanism and a pulley unit to move at least two casings of the support with each other.

2. Description of the Prior Art

Taiwanese Patent No. M284511 discloses a furniture elevator structure, which comprises a screw and a nut for rising and descending. It is necessary to use a longer screw for adjusting a higher position of the elevator. The adjusting speed is subject to the threads of the screw. When the density of the threads is high, the adjusting speed will be slow. But, it is able to support a heavier object. When the density of the threads is low, the adjusting speed will be fast. But, the supporting force of the screw and the nut is low. It is unable to support a heavier object. In addition, the longer screw needs more working procedures. This is not easy to lower the cost. The user takes more time and needs more strength to adjust the length with the longer screw.

Accordingly, it is necessary to improve the shortcomings of this furniture elevator structure.

### SUMMARY OF THE INVENTION

In view of the aforesaid shortcomings, the inventor of the present invention has devoted himself based on his many years of practical experiences to the development of an adjustable support device.

The present invention comprises a support, a lift mechanism, and a pulley unit. The support includes at least two casings. The lift mechanism is turned to drive the pulley unit and to move the casings for adjusting the length of the support.

A first objective of the present invention is that the support comprises at least two casings depending on the demand of the user. The support may comprise more casings which are moved with each other for adjusting the length of the support as desired.

A second objective of the present invention is that a threaded rod is risen or descended for moving the casings. With a pulley, the support is adjusted synchronously for its length. This is labor-saving for the user to adjust the length of the support.

A third objective of the present invention is that the threaded rod is screwed to a nut. The threaded rod and the nut provide a supporting force to bear the weight of the support, preventing the threaded rod from sliding down. The casings are limited to slide by themselves.

A fourth objective of the present invention is that a gear unit may be connected with a driving device for driving the support to rise or to descend. The driving device may be a handle or an electric motor.

A fifth objective of the present invention is that a driving gear may be connected with a linking rod to connect with a plurality of supports. A driven gear is connected with the driving device for rising or descending the plurality of supports.

### BRIEF DESCRIPTION OF THE DRAWINGS

FIG. 1 is a cross-section view according to a first preferred embodiment of the present invention;

FIG. 2 is another cross-section view according to the first preferred embodiment of the present invention;

FIG. 3 is a cross-section view according to a second preferred embodiment of the present invention;

FIG. 4 is a perspective view according to the second preferred embodiment of the present invention connected with a handle;

FIG. 5 is a perspective view according to the second preferred embodiment of the present invention connected with an electric motor;

FIG. 6 is a cross-section view showing another type of a lift mechanism according to the first preferred embodiment of the present invention;

FIG. 7 is a cross-section view showing another type of a lift mechanism according to the second preferred embodiment of the present invention;

FIG. 8 is a perspective view according to a third preferred embodiment of the present invention connected with a handle; and

FIG. 9 is a perspective view according to the third preferred embodiment of the present invention connected with an electric motor.

### DETAILED DESCRIPTION OF THE PREFERRED EMBODIMENTS

Embodiments of the present invention will now be described, by way of example only, with reference to the accompanying drawings.

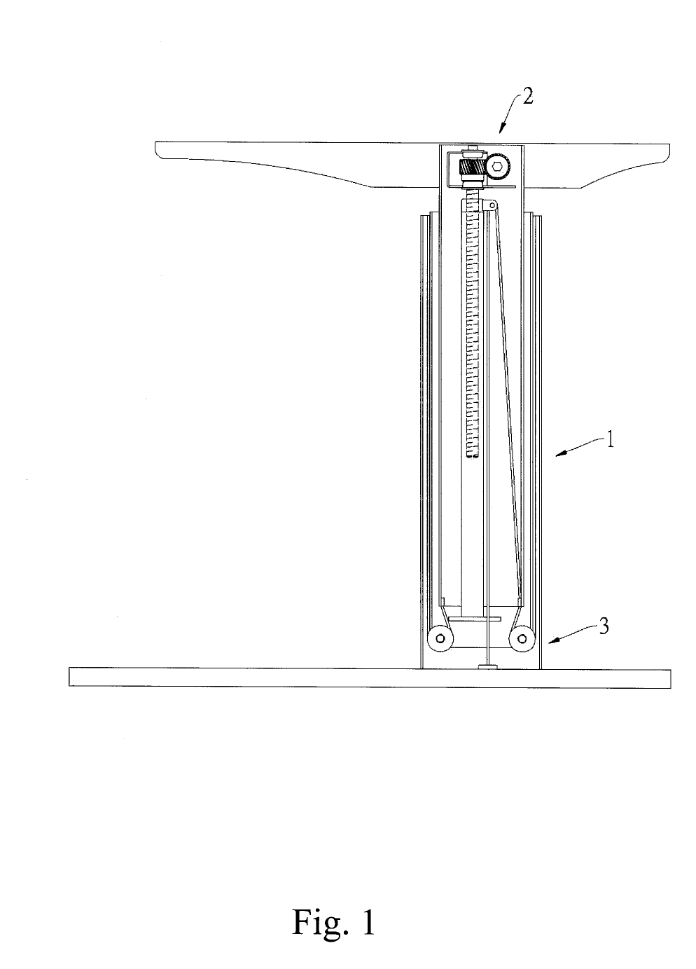

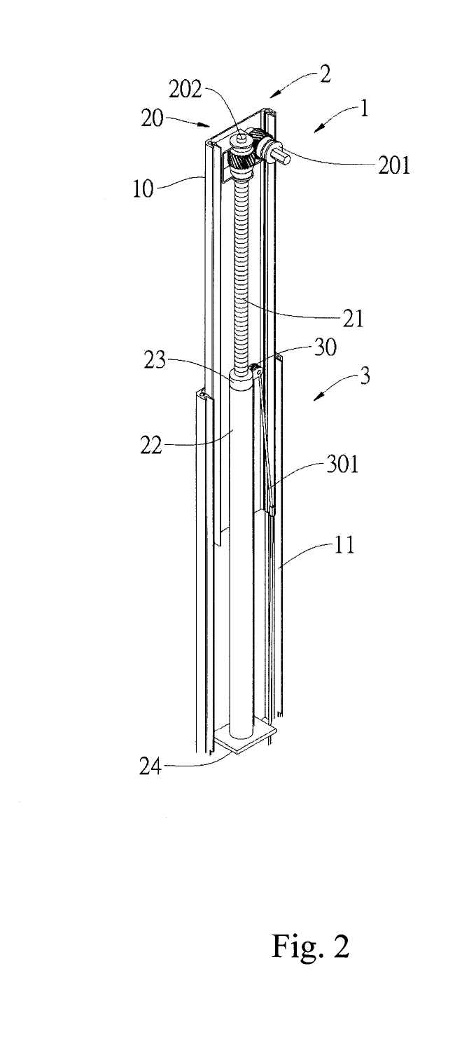

As shown in FIGS. 1 and 2, an adjustable support device according to a first preferred embodiment of the present invention comprises a support 1, a lift mechanism 2, and at least a pulley unit 3. The support 1 comprises a first casing 10 and a second casing 11 which are slidably connected to each other. The lift mechanism 2 is disposed in the first casing 10 and the second casing 11. The pulley unit 3 is also disposed in the first casing 10 and the second casing 11. The pulley unit 3 comprises at least a first pulley 30 and a first transmission belt 301. The first pulley 30 is connected to the lift mechanism 2. The first transmission belt 301 has a first end connected to the first casing 10 and a second end inserted through the first pulley 30 and connected to the second cashing 11. The lift mechanism 2 comprises a gear unit 20, a threaded rod 21, a sleeve 22, a nut 23, and a carrying base 24. The gear unit 20 is disposed at an upper end of the first casing 10. An upper end of the threaded rod 21 is connected to the gear unit 20. The nut 23 is disposed at an upper end of the sleeve 22. A lower end of the threaded rod 21 is inserted through the nut 23 and screwed into the sleeve 22. The sleeve 22 is connected with the first pulley 30. The carrying base 24 is disposed at a lower end of the sleeve 22 and connected with the second casing 11. When the gear unit 20 is turned by a user, the threaded rod 21 will be driven to rotate and move with respect to the sleeve 22. The first casing 10 is linked to move with respect to the second casing 11. With the transmission belt 301 and the first pulley 30, the lift mechanism 2 is operated with ease.

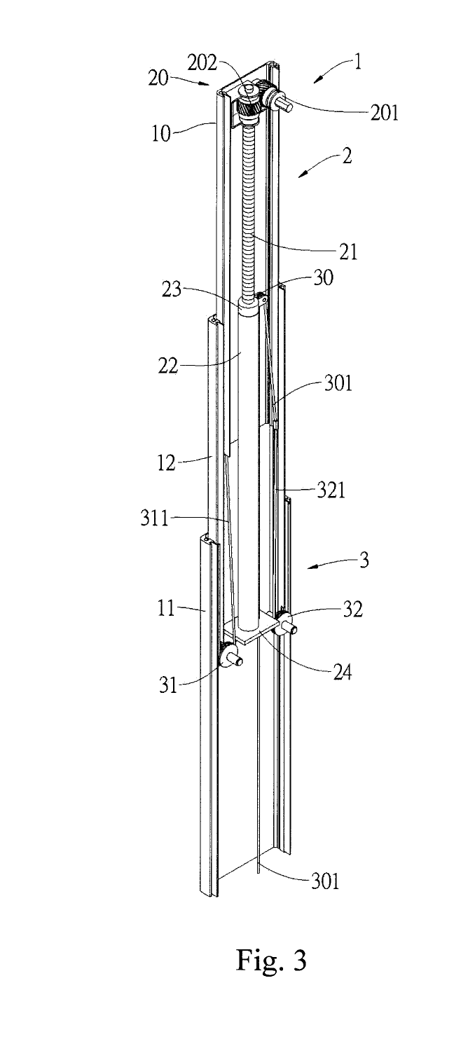

As shown in FIG. 3, at least a third casing 12 is provided between the first casing 10 and the second casing 11. The first casing 10, the second casing 11, and the third casing 12 are slidably connected to each other. The gear unit 20 is disposed at the upper end of the first casing 10. The upper end of the threaded rod 21 is connected to the gear unit 20. The nut 23 is disposed at the upper end of the sleeve 22. The lower end of the threaded rod 21 is inserted through the nut 23 and screwed into the sleeve 22. The sleeve 22 is connected with the first pulley 30. The carrying base 24 is disposed at the lower end of the sleeve 22 and connected with the third casing 12. One end of the first transmission belt 301 is connected to the first cashing 10, and the other end of the first transmission belt 301 is inserted through the first pulley 30 and connected to the second cashing 11. The pulley unit 3 further comprises at least a second pulley 31, at least a second transmission belt 311, at least a third pulley 32, and at least a third transmission belt 321. The second pulley 31 and the third pulley 32 are disposed at lower ends of two sides of the third casing 12, respectively. The second transmission belt 311 and the third transmission belt 321 are connected to lower ends of two sides of the first casing 10, inserted through the second pulley 31 and the third pulley 32, and then connected to upper ends of two sides of the second casing 11. When the gear unit 20 is turned, the threaded rod 21 will be driven to rotate and move with respect to the sleeve 22. The first casing 10 is linked to move with respect to the third casing 12, with the second transmission belt 311 and the third transmission belt 321 through the second pulley 31 and the third pulley 32 to bring the third casing 12 to move. The first casing 10 and the third casing 12 are risen synchronously. This helps the user to operate the lift mechanism 2 with ease. Furthermore, when the gear unit 20 is turned in an opposite direction, the threaded rod 21 will be driven to rotate and move with respect to the sleeve 22. The first casing 10 is linked to move with respect to the third casing 12, with the first transmission belt 301 through the first pulley 30 to bring the third casing 12 to move. The first casing 10 and the third casing 12 are descended synchronously.

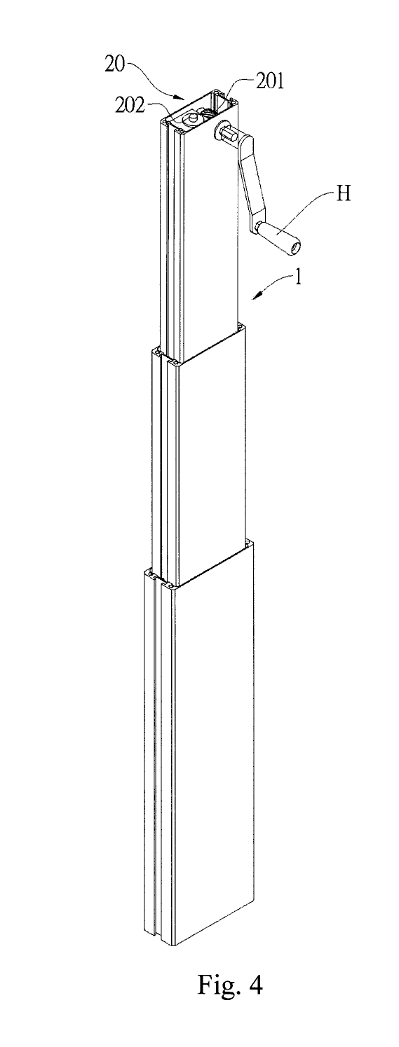

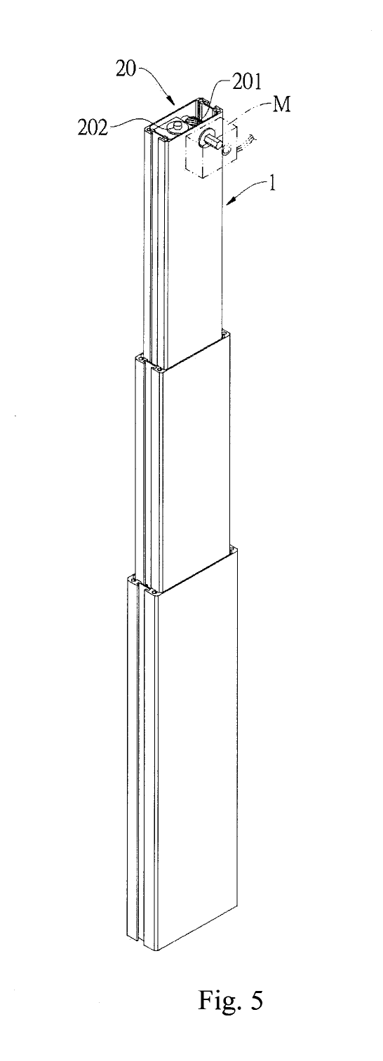

Referring to FIGS. 2 through 5, the gear unit 20 comprises a driving gear 201 and a driven gear 202. The driven gear 202 is disposed at the upper end of the threaded rod 21. The driving gear 201 meshes with the driven gear 202. The driving gear 201 is connected with a driving device to drive the gear unit 20 for driving the lift mechanism 2. The driving device may be a handle H or an electric motor M.

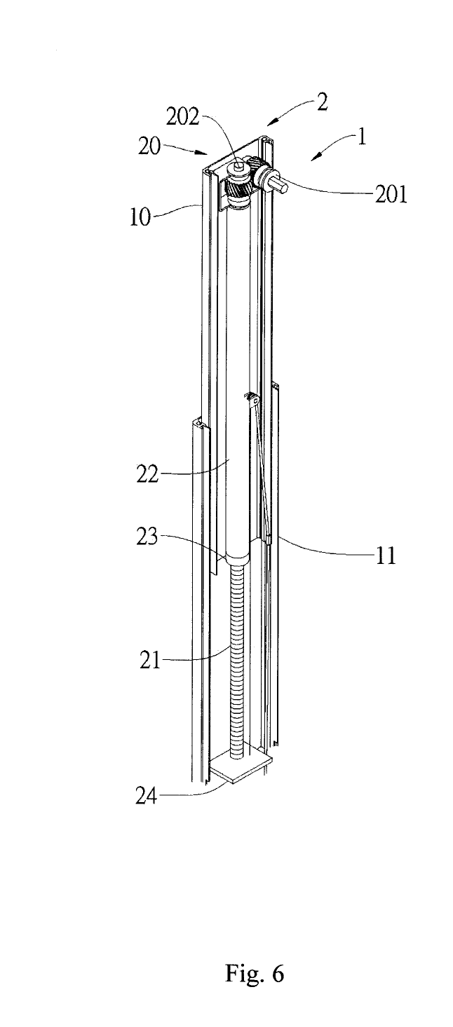

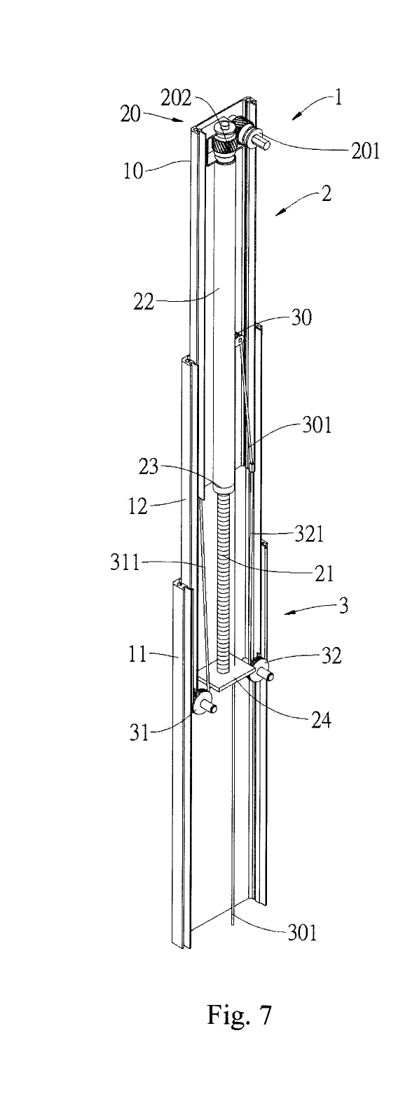

FIG. 6 and FIG. 7 show another embodiment of the lift mechanism 2. The gear unit 20 of the lift mechanism 2 is disposed at the upper end of the first casing 10. The upper end of the sleeve 22 is connected with the driven gear 202, and the lower end of the sleeve 22 is connected with the nut 23. The upper end of the threaded rod 21 is inserted through the nut 23 and screwed into the sleeve 22, and the lower end of the threaded rod 21 is connected to the carrying base 24. As shown in FIG. 6, the carrying base 24 is connected to the second casing 11. As shown in FIG. 7, the carrying base 24 is connected to the third casing 12.

The connection of the lift mechanism 2 may be in the form of the threaded rod 21 connected to the driven gear 202 and screwed into the sleeve 22, or in the form of the sleeve 22 connected to the driven gear 202 and the threaded rod 21 screwed into the sleeve 22.

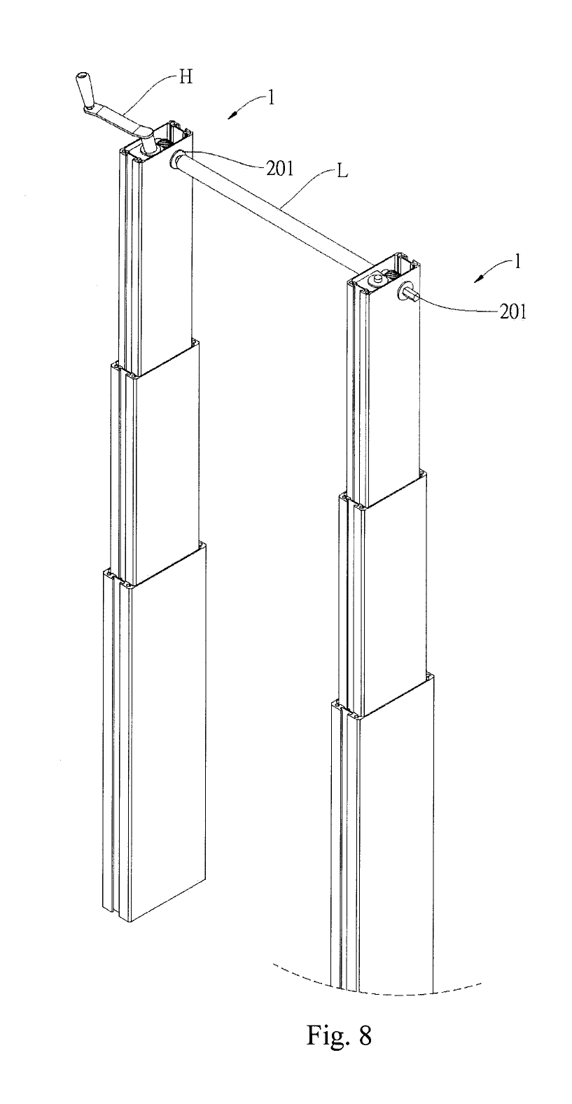

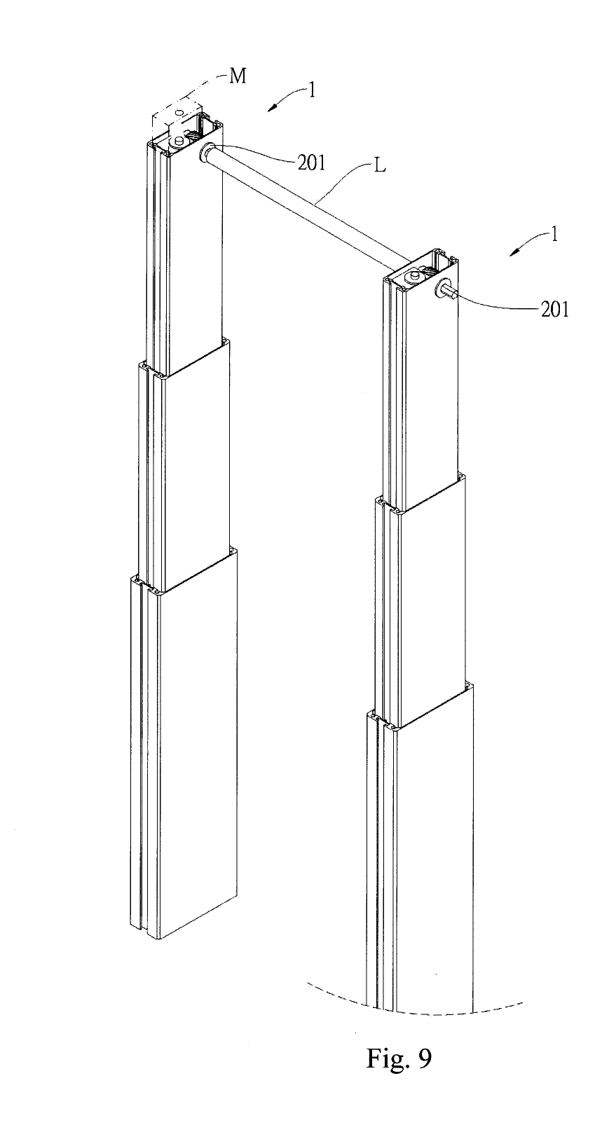

Referring to FIG. 8 and FIG. 9, the support 1 may be provided with a linking rod L to connect with another support 1 in series. The linking rod L is connected with the driving gear 201. The driven gear 202 is connected with the driving device. The driving device is the handle H, as shown in FIG. 8, or the electric motor M, as shown in FIG. 9.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An adjustable support device, comprising:
a support comprising at least a first casing and a second casing, the first casing and the second casing being slidably connected to each other;
a lift mechanism disposed in the first casing and the second casing; and
at least a pulley unit disposed in the first casing and the second casing, the pulley unit comprising at least a first pulley and at least a first transmission belt, the first pulley being connected to the lift mechanism, the first transmission belt having a first end connected to the first casing and a second end inserted through the first pulley and connected to the second cashing;
thereby, the lift mechanism being operated to drive the first transmission belt and the first pulley, and the first casing being moved with respect to the second casing.

2. The adjustable support device as claimed in claim 1, wherein the lift mechanism comprises:
a gear unit disposed at an upper end of the first casing;
a threaded rod having an upper end connected to the gear unit;
a sleeve having an upper end provided with a nut, the threaded rod having a lower end inserted through the nut and screwed into the sleeve, the sleeve being connected with the first pulley; and
a carrying base disposed at a lower end of the sleeve and connected to the second casing;
thereby, the gear unit being turned to bring the threaded rod to rotate and move with respect to the sleeve and to drive the first transmission belt and the first pulley synchronously, and the first casing being moved with respect to the second casing.

3. The adjustable support device as claimed in claim 1, wherein at least a third casing is provided between the first casing and the second casing, the first casing, the second casing, and the third casing being slidably connected to each other.

4. The adjustable support device as claimed in claim 3, wherein the pulley unit further comprises at least a second pulley, at least a second transmission belt, at least a third pulley, and at least a third transmission belt, the second pulley and the third pulley being disposed at lower ends of two sides of the third casing respectively, the second transmission belt and the third transmission belt being connected to lower ends of two sides of the first casing, inserted through the second pulley and the third pulley, and connected to upper ends of two sides of the second casing, thereby, the lift mechanism being operated to drive the pulley unit, and the first casing, the second casing and the third casing being moved with each other.

5. The adjustable support device as claimed in claim 4, wherein the lift mechanism comprises:
a gear unit disposed at an upper end of the first casing;
a threaded rod having an upper end connected to the gear unit;
a sleeve having an upper end provided with a nut, the threaded rod having a lower end inserted through the nut and screwed into the sleeve, the sleeve being connected with the first pulley; and
a carrying base disposed at a lower end of the sleeve and connected to the third casing;
thereby, the gear unit being turned to bring the threaded rod to rotate and move with respect to the sleeve and to drive the first transmission belt and the first pulley synchronously, and the first casing, the second casing and the third casing being moved with each other.

6. The adjustable support device as claimed in claim 2, wherein the gear unit comprises a driving gear and a driven gear, the driven gear being disposed at the upper end of the threaded rod, the driving gear meshing with the driven gear.

7. The adjustable support device as claimed in claim 6, wherein the driving unit is connected with a handle.

8. The adjustable support device as claimed in claim 6, wherein the driving unit is connected with an electric motor.

9. The adjustable support device as claimed in claim 5, wherein the gear unit comprises a driving gear and a driven gear, the driven gear being disposed at the upper end of the threaded rod, the driving gear meshing with the driven gear.

10. The adjustable support device as claimed in claim 9, wherein the driving unit is connected with a handle.

11. The adjustable support device as claimed in claim 9, wherein the driving unit is connected with an electric motor.

12. The adjustable support device as claimed in claim 1, wherein the lift mechanism comprises:
a gear unit disposed at an upper end of the first casing;
a sleeve having an upper end connected to the gear unit and a lower end provided with a nut and connected with the first pulley;
a threaded rod having an upper end inserted through the nut and screwed into the sleeve; and
a carrying base disposed at a lower end of the threaded rod and connected to the second casing;
thereby, the gear unit being turned to bring the sleeve to rotate and move with respect to the threaded rod and to drive the first transmission belt and the first pulley synchronously, and the first casing being moved with respect to the second casing.

13. The adjustable support device as claimed in claim 4, wherein the lift mechanism comprises:
a gear unit disposed at an upper end of the first casing;
a sleeve having an upper end connected to the gear unit and a lower end provided with a nut and connected with the first pulley;
a threaded rod having an upper end inserted through the nut and screwed into the sleeve; and
a carrying base disposed at a lower end of the threaded rod and connected to the second casing;
thereby, the gear unit being turned to bring the sleeve to rotate and move with respect to the threaded rod and to drive the gear unit synchronously, and the first casing, the second casing and the third casing being moved with each other.

14. The adjustable support device as claimed in claim 12, wherein the gear unit comprises a driving gear and a driven gear, the driven gear being disposed at the upper end of the sleeve, the driving gear meshing with the driven gear.

15. The adjustable support device as claimed in claim 14, wherein the driving unit is connected with a handle.

16. The adjustable support device as claimed in claim 14, wherein the driving unit is connected with an electric motor.

17. The adjustable support device as claimed in claim 13, wherein the gear unit comprises a driving gear and a driven gear, the driven gear being disposed at the upper end of the sleeve, the driving gear meshing with the driven gear.

18. The adjustable support device as claimed in claim 17, wherein the driving unit is connected with a handle.

19. The adjustable support device as claimed in claim 17, wherein the driving unit is connected with an electric motor.

20. The adjustable support device as claimed in claim 6, wherein the driven gear is connected with a handle; and the driving gear is connected with one end of a linking rod, another end of the linking rod being connected with a driving gear of another support.

21. The adjustable support device as claimed in claim 9, wherein the driven gear is connected with a handle; and the driving gear is connected with one end of a linking rod, another end of the linking rod being connected with a driving gear of another support.

22. The adjustable support device as claimed in claim 6, wherein the driven gear is connected with an electric motor; and the driving gear is connected with one end of a linking rod, another end of the linking rod being connected with a driving gear of another support.

23. The adjustable support device as claimed in claim 9, wherein the driven gear is connected with an electric motor; and the driving gear is connected with one end of a linking rod, another end of the linking rod being connected with a driving gear of another support.

24. The adjustable support device as claimed in claim 14, wherein the driven gear is connected with a handle; and the driving gear is connected with one end of a linking rod, another end of the linking rod being connected with a driving gear of another support.

25. The adjustable support device as claimed in claim 17, wherein the driven gear is connected with a handle; and the driving gear is connected with one end of a linking rod, another end of the linking rod being connected with a driving gear of another support.

26. The adjustable support device as claimed in claim 14, wherein the driven gear is connected with an electric motor; and the driving gear is connected with one end of a linking rod, another end of the linking rod being connected with a driving gear of another support.

27. The adjustable support device as claimed in claim 17, wherein the driven gear is connected with an electric motor; and the driving gear is connected with one end of a linking rod, another end of the linking rod being connected with a driving gear of another support.
